(19) United States
(12) Patent Application Publication
(10) Pub. No.: US 2002/0029170 A1
(43) Pub. Date: Mar. 7, 2002

(54) Visualization system

(76) Inventors: Daniel Gasser, Bern (CH); Frank Weinberg, Bern (CH)

Correspondence Address: PEARNE & GORDON LLP, 526 SUPERIOR AVENUE EAST, SUITE 1200, CLEVELAND, OH, 44114-1484, US

(21) Appl. No.: 09/804,334

(22) Filed: Mar. 12, 2001

(30) Foreign Application Priority Data
Mar. 13, 2000 (CH) 00 477/00

(51) Int. Cl. G06F 17/60

(52) U.S. Cl. 705/26; 705/16; 705/1

(57) ABSTRACT

The method presented here for the visualization of products at a point of sales makes it possible for a supplier to put together his product programs, which he would like to visualize, off-line or on-line and to change, to delete or to add to these at any time and to have them automatically run at one or several sales point(s). A product program of this kind can be defined for a certain period of time, during which the program is then “transmitted” every day. Once the program cycle has been completed it starts from the beginning once again.

This takes place in such a manner, that offering units, for example, servers, which organize the visualization information and which maintain in readiness the units carrying out the visualization, communicate as servers, with the terminals, resp., clients, as suppliers in the internet through the internet network for the visualization through channels and that these terminals as units automatically obtaining and processing data are assigned to one or to several servers.

The invention concerns a system for the remote-organizable and remote-controllable visualization of product advertising in text, picture and sound, for the information of the customers.

The system serves to inform customers on the spot about current products, prices, special offers, also, however, about the weather, stock exchange, etc. For this purpose, a supplier sets up one or several computers with displays (terminals) or projectors in its premises. Via the displays or projection, thereupon the predefined and remote-organized programmes (pictures, advertising films, texts, etc.) are shown by means of remote control.

In doing so, every supplier has the possibility to put together its own product programmes and to change these, to delete these or to add to these at any time. A product programme can be defined for a certain time period, during which the programme is then “transmitted” daily. Once the programme cycle has been completed, it starts from the beginning again.

The system essentially consists of two functional parts: of an administration unit (as a rule a server) and of one, resp., several terminal units (as a rule these are computers with one or with several displays, on which the product programmes can be shown). The data track between administration and terminal is designated as channel.

The administration unit (it can also be several units) is installed on a high-performance server, which, for example, is located with a provider and which advantageously is based on internet technology. This means, that from every client (on which a conventional browser is installed, for example, IE 4.01 or higher), the channels can be administered, pictures, audios and videos can be loaded, users managed, and so on.

On the terminal, advantageously a self-configuring software is installed, which is automatically activated when starting-up the machine. To do this, for example, the entering of telephone number, internet provider, password and a channel number are required. Following the completed configuration, the software immediately attempts to establish a first connection with the server. In doing so, thereupon all necessary information for the operation is loaded. This software can be developed as a Win32 application. As a result of this, it is of course not a pure internet application. This, however, makes it possible that a lot more media formats can be read and depicted than is possible in the case of pure internet applications. After the installation, no user interaction shall be necessary anymore on the terminal computer.

After the starting-up, the terminal makes an enquiry with the administering server as to whether, for example, any changes to the product program have taken place. The enquiry takes place within a predefined time interval. The enquiry interval can of course be changed at any time. The server checks the enquiry and, if any changes to the program have been found, it transmits the new media material, which are the product illustrations, to the enquiring terminal. The terminal thereupon copies the material into the correct directories and can then immediately also commence with the publishing of the new material, the pictures of the new products, i.e., with depicting them on the monitors at the point of sale. In the case of films, depending on the size of the films and the transmission speed of the modem, in part rather long waiting times have to be accepted during the downloading of the media material to the terminal.

Fundamentally, the procedure is as follows: A customer has one or several channels protected with a password. A channel, for example, has sub-channels up to, for example, 4 levels. On the lowest sub-channel then, the product programmes can be recorded. A programme has a programme content of several media for the product advertising (pictures, films, text, etc.). For this, a media archive is prepared. Per customer, for example, one or several media archives can be maintained with the administration. A media archive is a kind of depository, where those media can be recorded in advance, with which one has the intention of working. Therefore when putting together the product programme it is only necessary to produce a link to “the article or the articles” recorded in the archive beforehand. One then can define a maximum limit for the number of pictures or MB per customer. Media archives can also be made available to any channel owner. This results in the possibility of corresponding new services. Services of this kind can offer pictures, HTML pages or films to the channel owners.

Also advantageous is the recording of data for statistical purposes. Thus one can foresee a statistical page, on which the current occupation of every customer can be seen. Examples of displayed fields are: Customer, contact person, number of media, space volume in MB. One channel can have between one and a multitude of product programmes. Every programme is, for example, played back daily at a defined time (e.g., from 08:00 h to 12:00 h). It is, however, also possible to define a special programme, which for a certain time period (e.g., 1 hour) with immediate effect or through a “from-to” time input overrides the currently displayed programme.

During those time periods, when no programme is running (because none has been defined), a still picture or a fill-in film runs, which is provided, for example, by one of these services mentioned above. This picture is also installed during the installation of the terminal and shall not be changed anymore later on (without user interaction). A programme can be limited by the administration by means of a time limit. The customer can “configure/fashion” the time period made available himself A product programme in preference has a starting date and a finishing date. If the finishing date is void, then this signifies, that the programme runs until it is recalled. If two programmes overlap, then in all cases the younger one (the more up-to-date one) is shown. For better information, the user via the administration can be made aware, if in his configuration product programmes are overlapping with respect to time.

By the assignment of the sequence, a media element is actively taken over into the programme. The sequence, however, can be changed at any time. If a media element is recorded and the sequence, resp., the position coincides with that of an existing media element, then the existing media element is moved downwards by one position (e.g., from 3 to 4). If a position (sequence) is deleted, then a new through numbering takes place. There is also the possibility, that the programme can be complemented by services, for example, one of the available media services. This would be, e.g., the weather forecast, stock exchange, etc. This then also takes place in an indication of sequence.

Concerning the playing times: The playing time of every individual media element can be defined individually. In case of films, on principle the length is read and automatically calculated. The times are indicated, for examples, in seconds (sec) and therefore the second is considered as the smallest time unit. In order to prevent a possible delay in the case of large pictures, a so-called pre-loading could be programmed, which every time already prepares the next picture in advance.

The assignment of the media elements can take place at any level (depending on the authorization). This means, on the channel, sub-channel, etc. If on a higher level channel a media element is assigned, then this is automatically passed on to the channels situated below it. The passing on (“bequeathing”) assignment of the elements of a media element can only be carried out by an administrator or by a Super User. Other users have no overlapping rights. The passed on media material cannot be deleted by a user with less rights. The user only has the right to change the sequence. Present on the same page apart from this is a previewing function (previewing of individual pictures in the archive or of a complete product programme) about the integration of the passed on (“bequeathed”) media elements, for example, pictures with texts, in the individual product programmes. This is necessary, in order to verify the correct position and length of the text.

Advantageously, there are three hierarchically classed authorization groups: the administrators, the Super Users and the users.

Administrators are employees, for example, of the server operators or of other persons with the authorization to provide support. Administrators are responsible for the maintenance of the system and they have the right to open new channels and sub-channels. Super Users are owners of channels. This means, the topmost responsible person of a channel=channel administrator. Die Super Users are responsible for the recording of their user data and for the defining of their rights. Users are all persons, who have the authorization to work on channels and sub-channels.

In case of the authorizations, for example, the principle of passing on (“bequeathing” is applicable. If a right has been set on a superordinate channel, then it is also passed on (“bequeathed”) to the lower ones.

Texts belonging to pictures are freely definable and are displayed, for example, in the Arial font. Advantageously, only a single font size is defined. The text can optionally be displayed in black or white and in three zones (top, middle and bottom). On request, however, the text of course can be displayed in selectable colours, selectable font sizes, selectable text alignment and in 3 zones.

The downloading: The computer with the media data can supply several terminals. Per terminal, the Super User of the channel can define the downloading intervals. The smallest time unit amounts to 1 minute. And the language: The advertising application can be offered in German, English, French, Italian, Spanish, resp., in any language at all. The selection is controlled at the user level. This means, per user one language can be selected. A further possibility for a downloading management consists in the fact, that for the advertising of external promoters a log-file is set-up, which per automatic downloading interval transmits this, resp., these per e-mail to the Super User or to another defined person. This log-file serves as a kind of receipt for switched-in picture-, audio- and film material per unit of time.

Following this comprehensive and illustrative summary, the invention is now discussed in detail on the basis of Figures.

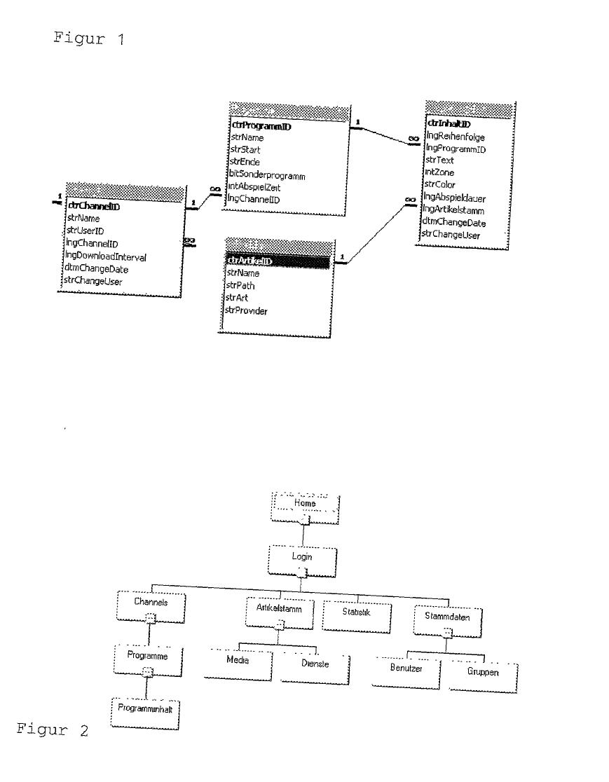

FIG. 1 illustrates an example of a possible data structure for the administration of the product programmes for the terminals.

FIG. 2 schematically illustrates the organizational structure of the administration unit, here the server part, from which the media material is arranged.

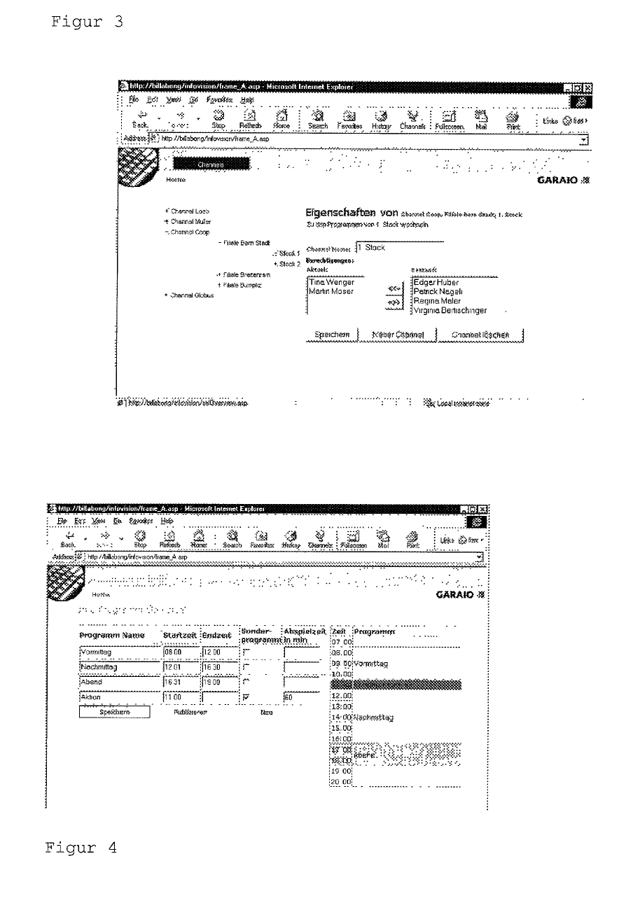

FIG. 3 illustrates an example for a channel page, as it is displayed on the monitor screen.

FIG. 4 shows an example for the programming with regard to time of a product programme page.

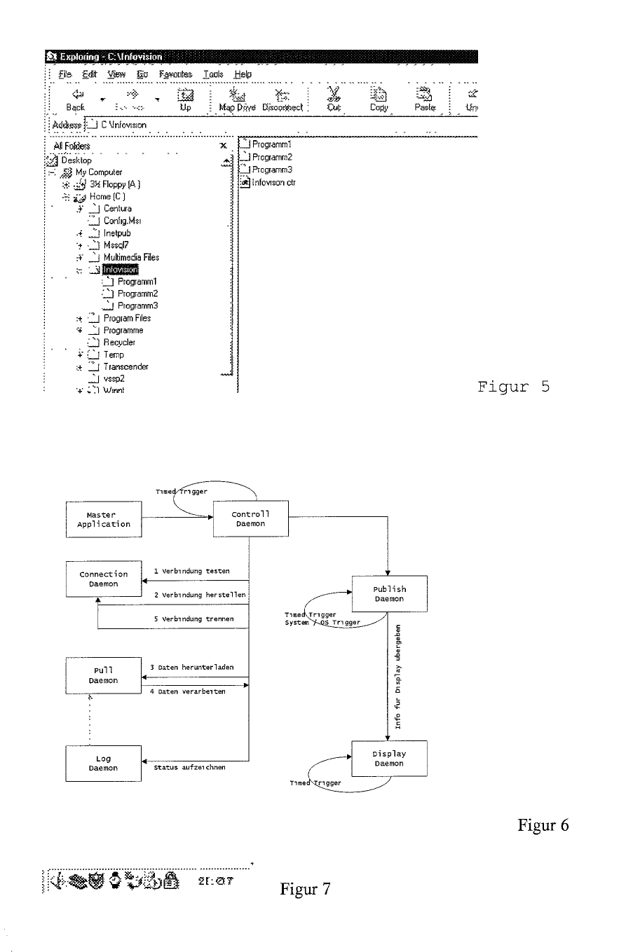

FIG. 5 depicts an example for an arrangement of the data files on the terminal part.

FIG. 6 schematically illustrates an example for the running of a terminal routine.

FIG. 7 depicts an example of how a programme icon can be placed.

The data model of this example of an embodiment is illustrated in FIG. 1. Here it encompasses 4 tables: Channel; (product) programmes; (product) programme content and article master. For the server part—there the administration or management of all data takes place—a databank server is utilized. The databank server in the case of this example is an SQL server version 7.0. For the terminals on the other hand, no databank is necessary. All data are filed in a file structure. The embodiment illustrated here is based on a databank structure with 2 tables for the user administration, 2 tables for the menu control and 4 tables for the channel—and programme data of the data administration. This results in a data model, as is partially illustrated in FIG. 1. For reasons of clarity, only a part of the data model is depicted. The part shown concerns the most complex part—namely the programme—and channel tables. These tables are listed in detail in the table below.

The table Channel, for example, encompasses the following attributes:

[chemical structure]

The table (product) programmes, for example, comprises the following attributes:

[chemical structure]

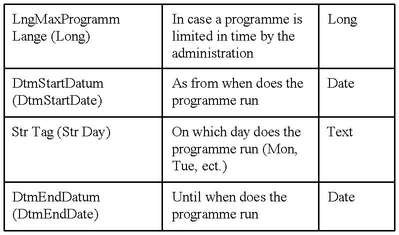

The table (product) programme content, for example, encompasses the following attributes:

| Internal name | Description | Data type |
|---|---|---|
| CtrInhaltID | Unequivocal | Long |
| (CtrContentID) | identification of a content | |
| LngReihenfolge | Sequence position, in | Long |
| (LngSequence) | which the content is to be | |
| | displayed | |
| LngProgrammID | Reference to the table | Long |
| | programmes | |
| StrText | Display text | Text |
| IntZone | In which zone shall the | Integer |
| | text be displayed | |
| StrColor | Hex value of the display | Text |
| | colour (black or white) | |
| LngAbspieldauer | How long shall the media | Long |
| (LngPlayduration) | be displayed (in sec) | |
| BitChange | = True if the text or the | Boolean |
| | media has been changed | |
| DtmChangeDate | Date of the change | Date |
| StrChangeUser | Users, who have carried | Text |
| | out the last changes | |
| LngArtikelstamm | Reference to the table | Long |
| (LngMasterarticle) | article master | |

The table Article master, for example, comprises the following attributes:

| Internal name | Description | Data type |
|---|---|---|
| CtrArtikelID | Unequivocal | Long |
| (CtrArticleID) | identification of an | |
| | article | |
| StrName | Speaking article name | Text |
| StrPath | Filing path of the | Text |
| | medium | |
| StrArt | Type of medium (picture, | Text |
| | flash, MPEG2, etc.) | |
| StrProvider | Identifies the article: | Text |
| | Either SMG or cannel | |
| | owner | |

For the server part (web part), web outlets are foreseen. The web outlet contains the hierarchic structure and provides information about the navigation of a web solution. In accordance with FIG. 2, the following structure is depicted as an example:

1. Login: A user logs into the system by means of UserIdentification (UID) and Password (PWD). If the system recognizes the user, then access to the system is granted in accordance with the corresponding group classification.

2. Master data: There all master data are administered—users, groups, menu control, etc. Access there is only granted to those persons, who have been recorded in the administrators group.

3. Article master with media and services: The page Services is only accessible to the administration of the services. The page Media is operated by the administrator as well as by the Super User.

4. Media: Is the article depository, where all media (pictures assigned to individual products, texts, films, sounds, etc.) are saved (stored). Every Super User of a channel has his or her own depository.

5. Statistics: These pages serve for the evaluation. For example, a statistic about the space requirements of the individual operators/channel owners.

6. Channel: Overview of the channels and sub-channels. Only an administrator can open, delete or block channels and sub-channels. A Super User can edit the channels. Users have no rights at channel level. On the channel page it can also be defined, at which time interval the client is to start an update enquiry with the server.

7. Programmes: Here the product programmes are defined. A Super User has the possibility of defining between 1 and N programmes. Apart from this, he has a special programme at his disposal, which is played for a certain length of time. A user on his own sub-channel has the right to establish, to edit to delete and to view programmes=>>Programme content page.

8. Content: Here the product programmes are compiled. This means, media are taken over from the article master and these are then placed in the programme in the desired sequence. The playing time of a programme is defined. It is also possible to take over a service and to place it at a certain position within the programme.

The channels can be edited by administrators and the corresponding Super User. As FIG. 3 illustrates as an example, the channel pages can consist of two halves. On the left-hand side, the channels and sub-channels are depicted in the form of a tree (Tree). The administrator can navigate through the whole tree, open sub-channels and then access the product programmes belonging to them. A Super User solely has the right to navigate through his channels with the sub-channels. A user has no tree and can only establish, edit and delete programmes in his sub-channel. On the right-hand side, the respective characteristics of the channel are represented. Names can be changed. Authorizations can be assigned and also new channels recorded. From here, it is also possible to change to the programme page of the current channel. From this view, it is also possible to change into the programme overview. There then the programmes are recorded, deleted, edited and published.

The monitor screen page of the product programmes: On this page, all programmes of a sub-channel are listed. It is thereupon possible to change the characteristics (names, playback times, etc.). The administrators, Super Users and users in addition to this have the possibility of recording new programmes and of deleting programmes.

A programme page of this type could, for example, have the appearance shown in FIG. 4. On the left-hand side, product programmes are recorded and processed—on the right-hand side a graphic representation of the running time sequence of the programmes is depicted.

Before the data can be taken over by the terminal, they have to be prepared and packaged. This can be carried out by a so-called publishing service (a subroutine). In order that this service knows, when it has once again received new data and has to prepare them, it is started with the button “Publish”. It would be conceivable, that instead of user interaction (clicking on the publishing button), the publishing service is started every time the change is saved. This, however, would have the consequence, that the user time and again would be blocked over a longer time period. For this reason it is more advantageous, that the user first makes all the changes and thereupon re-publishes the programme. It would also be conceivable, that an asynchronous process searches through the databank for publishable entries. This would eliminate the need for the publisher button. A combination of these possibilities cannot be excluded. By clicking on a programme, the contents of the programme are loaded and displayed on the right-hand side.

On the product programme contents page, the programmes are then put together. This means, the pictures, videos, sounds, etc., are loaded, texts defined, sequences determined and the service subscribed to. This can be implemented by administrators, Super Users and users with the corresponding rights. For the administrator, here an additional function is available, where he or she can assign a certain media to several sub-channels. Also the Super User can make use of this function, this of course only on his own channel. The media is then copied to all subordinate programmes. A user cannot delete the material assigned to him, but can, however, change the sequence and the duration of the playback.

The terminal part, that is the other side, which is installed on the customer's premises at the POS (point of sale), for example, consists of a VB (Visual Basic) program with an integrated browser (Internet Explorer). This application takes over the controlling of the application. Although only servant, it is responsible, that the correct services are started at the right point in time and that they carry out the correct commands. The necessary information for this the application obtains from the control—or information files. The data and scripts of the terminal part are filed in a fixed structure, as is depicted, for example, in FIG. 5: In the root folder (Infovision) there is the control script (Infovision.ctr) and all possible programmes. In every programme folder once again a script is the content script (Programm1.ctr).

On the terminal computer, the master application is to be found in the system tray, the field in the Windows bar on the right, in the form of an icon, refer to FIG. 7. Through this icon, in case of a problem or of administration work, the application could be controlled with user interaction. A “normal” interface is not foreseen, because the application after all is primarily controlled by means of control files.

The software on every terminal computer is split-up into the following components, namely into application, control and display.

The schematic running sequence of one- , resp., of the terminal routine is illustrated in FIG. 6. The master application is solely responsible for the standard Windows application functions. The further functionality is assured through two “Daemons” in asynchronous processes. One “Daemon” carries out a utility function for the administration or co-ordination, which is not called-up by the user. This program runs in the background and is only activated in case of need.

The connections in the diagram above between the application, the “Control Daemon” and the “Publish Daemon” are actually only present in order to indicate, that these sub-systems have mutual access to their functions and entities. However, no structured program sequence between these closed-in-themselves systems takes place.

The “Control Daemon” activates itself at the time intervals defined in the settings. Thereafter it verifies, that a connection to the server is in place (1). If no such connection exists, then one is established by means of RAS (Remote Access Service). This task is taken over by the “Connection Daemon” (2).

Once a line has been established, the “Pull Daemon” downloads the one first file from the web server by means of the HTTP protocol (3). The “Control Daemon” subsequently analyses this file (4). The “Control Daemon” subsequently carries out the listed commands, This signifies, that if media or other files have to be downloaded, the “Pull Daemon” then for every file receives its command. If only administrative work remains to be carried out, then the connection (if it has been established beforehand) is interrupted once again (5) and subsequently the administrative tasks are carried out. (If on the terminal computer abnormal conditions occur, also a reporting to the server could make sense. A “Log Daemon” should be foreseen right from the beginning. The data are now subsequently processed in such a manner, that they are available for the “Publish Daemon”.

Independent of this process, the “Publish Daemon” and the “Display Daemon” continually work together. The “Display Daemon” at the time intervals defined in the programmes changes the medias and displays these in the containers foreseen for this purpose. Which programme is to be displayed, is notified to the “Display Daemon” in the case of every programme change by the “Publish Daemon”.

The “Publish Daemon” notices every time something happens to the files during Screen-On in the file structure. In other words, when a programme file changes, disappears or is newly added, then the “Publish Daemon” reads the new data from the control file into the memory and acts autonomously in dependence of the instructions received. This procedure, the practically complete “Daemonization” of the terminal process—and not solely the notification by the “Control Daemon”—leaves open the possibility of a further expansion.

This architecture is built-up in a mixture of COM library and Windows application. While the “Master Application” is a normal application established in VB, the Daemons are represented as COM libraries. By means of this procedure, the collaboration of the various Daemons is assured and does not contain any hidden surprises in the development. The data structures are internally represented in the COM library in the form of classes. As a result of this, there should be nothing to obstruct a later expansion of the data structure and the expansion should be made more easy.

The control scripts contain the following: The hidden file contains information, which normally does not have to be changed. This information is as follows (the list is not conclusive): Name Dial Up Network/RAS connection, UID of the provider, telephone number of the provider, password of the provider, down loading time intervals, standard paths, file folder on the server, and so on. This file contains all control information of the programmes, which are to run on this machine: Active programmes and where they are located (paths), Playing times of the programmes, et cetera. In every program folder then there is a display control file. This contains all information about the contents of a programme: Display time of a picture, text of a picture, sequence of the media, and so forth.

1. System for the visualization of information, in particular product information, at selected locations through the organization and controlling of the visualization content from any locations, which are not the visualization locations, characterized by one or several administration unit(s), which organize(s) and maintain(s) in readiness the administration of the visualization information, which are driven automatically by at least one, in preference a multitude of visualization units carrying out the visualization automatically, in order to collect the product information maintained in readiness for the visualization and to play it back automatically.

2. System in accordance with claim 1, characterized in that the administration units, which organize the visualization information and maintain it in readiness for the visualization units carrying out the visualization, communicate as suppliers in the internet through the internet network or by means of intranet and its network as server with the terminals, resp., clients for the visualization through channels and these terminals as units automatically obtaining and processing the data on offer are assigned to one or to several servers.

3. System in accordance with one of the claim 1 or 2, characterized in that the servers are service provider servers and that the terminals, resp., clients are computer-assisted visualization installations at sales outlets, resp., “points of sale” and that they exchange data through channels.

4. Method for the organization of the administration of the units organizing and maintaining in readiness the visualization information in accordance with one of the claims 1 to 3, characterized in that the administration of the visualization information is organized and maintained in readiness for the call-up in the form of a fixed data model by means of linked tables.

5. Method in accordance with claim 4, characterized in that the data model contains at least the tables for the definition of the channels, for the definition of the product programme, for the definition of the product programme content and for the definition of the article master.

6. Method in accordance with one of the claims 1 to 5, characterized in that the server/the servers through a web outlet with a hierarchic structure is organized/are organized in such a manner, that for the automatically enquiring terminals depending on the authorization the data maintained in readiness for them are released for downloading.

7. Method for the automatic running of a terminal in accordance with one of the claims 1 to 3, characterized in that the automatic running of the enquiry and the working-off through Daemons is implemented in a program file (COM-File) association in such a manner, that individual Daemons are mutually connected to become a Super-Daemon.

8. Method in accordance with claim 7, characterized by a program association of Daemons in the form of program files (for example, COM-files) in such a manner, that a control Daemon fed by a master application on the one hand drives a Publish-Daemon, which for its part drives a Display-Daemon and on the other hand a Connection-Daemon, and a Pull-Daemon, whereby the Control-Daemon, the Publish-Daemon and the Display-Daemon have a time-dependent self-starting function.

9. Method in accordance with claim 7 or 8, characterized in that a control function, resp., Daemon together with a publish function, resp., -Daemon form a super function, resp., Super-Daemon, with the help of which the terminal function runs automatically.

10. Arrangement for the realization of the system in accordance with claim 1, consisting of: at least one server for the administration of the administration units organizing and maintaining in readiness visualization information and at least one terminal for the visualization units automatically carrying-out the visualization, whereby the terminal can automatically drive the server, in order to collect the product information maintained in readiness for the visualization and in order to automatically play it back.

11. Device for the implementation of the method for the automatic processing of visualization information at a point of sale, characterized by a terminal computer, with one or several visualization device(s), which terminal computer has a program, with which the automatic running of the enquiry and working-off through Daemons is implemented in a COM-file association in such a manner, that individual Daemons are mutually connected together to form a Super-Daemon.

12. Method in accordance with claim 11, characterized in that the terminal computer drives a program with a program association of Daemons in the form of program files (for example, COM-files) in such a manner, that a Control-Daemon supplied by a master application on the one hand drives a Publish-Daemon, which for its part drives a Display-Daemon and on the other hand a Connection-Daemon, and a Pull-Daemon, whereby the Control-Daemon, the Publish-Daemon and the Display-Daemon have a time-dependent self-starting function.

13. Data storage medium containing programs for the implementation of the method in accordance with one of the claims 4 to 9.

14. Data storage medium in accordance with claim 13 containing a ready for installation set for the administration unit and/or the visualization unit for the utilization in accordance with one of the claims 1-12
